(19) United States
(12) Patent Application Publication
(10) Pub. No.: US 2010/0274496 A1
(43) Pub. Date: Oct. 28, 2010

(54) DEVICE FOR MEASUREMENT OF TRANSPORT SYSTEMS

(76) Inventors: Stefan Hummel, Haseldorf (DE); Matthias Pirsch, Hamburg (DE)

Correspondence Address: COLLARD & ROE, P.C., 1077 NORTHERN BOULEVARD, ROSLYN, NY, 11576, US

(21) Appl. No.: 12/734,944

(22) PCT Filed: Dec. 5, 2008
(86) PCT No.: PCT/DE2008/002010

§ 371 Date: Jun. 7, 2010

(30) Foreign Application Priority Data
Dec. 6, 2007 (DE) 10-2007-059-166.9

(51) Int. Cl. G06F 19/00; G01N 21/00; G01J 1/58

(52) U.S. Cl. 702/19; 359/368; 250/458.1

(57) ABSTRACT

The invention relates to a device (1) for optically measuring properties of transport systems (50) in membranes (40), particularly carrier or channel proteins. In order to be able to measure the properties of biological transporter molecules (50) with a high throughput, the invention proposes that the device (1) comprise an optical measurement unit (2) and a data processing unit (6) having a process control (7) and a data capture.

The invention relates to a device for optical measurement of properties of individual transport systems in membranes, particularly of carrier proteins, channel proteins, or other systems for transport of substances through biological membranes, such as secretion mechanisms.

Biological membranes separate cells from the external medium, and the individual cell compartments of the cells from one another. Transport systems such as transport proteins and channels selectively control the passage of substances through these membranes. Functional disruptions of these transporters and channels are responsible for numerous wide-spread illnesses. Among the 100 medications most sold in the USA in 2004, membrane transporters were the most frequently occurring group. In total, at present more than 100 transporter targets are being researched by the pharmaceutical companies, showing what an immense economic importance they have.

Measurement methods with which properties such as the transport rates of specific substrates through the transporter target and the influence of active substance candidates can be evaluated are required for the development of such active substances. In this connection, in particular, methods are needed that can characterize the individual target molecules even in automated manner, at high throughput.

Electrical measurements can be used for the analysis of transport rates of ions and charged particles. This method is already being used, at high throughput, in biotechnological and pharmaceutical research. However, it is limited to charged transport substrates and is therefore generally used for the group of the ion channels.

For the transport of non-charged molecules such as amino acids, peptides, sugar compounds, and fatty acids, but also biological macromolecules such as RNA, DNA, and proteins, a fluorescence analysis method is suitable, which is referred to as fluorescence analysis of individual transporters (nanoFAST). In this connection, a lipid membrane or biological membrane or cells that contain(s) the transport systems is/are applied to a surface of a carrier structured with measurement chambers. For example, membrane proteins that can be channels or carriers are possible transport systems. A substrate is then added to the transport system or produced by the cells, which substrate is marked with a fluorescence dye or makes intrinsic fluorescence available. The transport by way of the membrane can then be optically measured by means of fluorescence. The optical measurement can take place, for example, by means of confocal laser scanning microscopy, wide-field fluorescence microscopy, or by means of TIRF microscopy (Total Internal Reflection Fluorescence). In the case of TIRF microscopy, excitation light is radiated in at a totally reflective angle, so that fluorescence dyes are excited selectively, within the spatial expanse of an evanescent field.

Since no suitable devices exist, up to now it has only been possible to perform these measurements on a laboratory scale. However, there is a great need for using the method within an industrial framework, as well, for example in biotechnology research and drug development.

It is therefore the task of the invention to propose a device by means of which the properties of transporter molecules can be measured at high throughput.

This task is accomplished in that a device for optical measurement of properties of individual transport systems in membranes, particularly of carrier proteins or channel proteins, is proposed, which has an optical measurement device and data processing electronics having a process controller and a data capture and evaluation unit. The functions of the microscope are controlled by the process controller, and the measurement is carried out automatically. After process-controlled capture of the measurement data, their automatic evaluation takes place. By means of this automation, a high sample throughput is advantageously possible.

In a preferred embodiment, a TRIF microscope is provided as an optical measurement device. By means of the TRIF measurement, preferentially those fluorescence dyes that were transported into a measurement chamber by the transport system, in each instance, by way of the membrane, are excited. In contrast, fluorescence dyes outside of the measurement chamber are not excited. This makes a more precise measurement possible.

A further increase in the sample throughput becomes possible in that a sample manipulator that can be controlled by means of the process controller is provided. This manipulator can take on multiple tasks, including prepping of the biochip for the measurement, charging of the biochip with samples and substrates, and placement into the measurement apparatus.

The applicant has already filed the German patent application DE 10 2007 016 699.2, which proposes a biochip, which is essentially configured as a transparent layer having multiple measurement chambers, as a sample carrier. The biochip allows more precise and better reproducible measurements. It is advantageous if the device according to the invention is set up for measuring such or similar biochips.

In a preferred embodiment of the biochip, a gold layer having smaller openings then the measurement chambers that lie underneath is provided on the top of the biochip, so that the measurement chambers are partially covered by the gold layer. When measuring such biochips, it is advantageous if the optical measurement device has a beam guide that is close to the TIRF angle, but does not yet reach this angle. Here, the limit angle of the total reflection is referred to as the TIRF angle; this angle can be calculated by means of Snell's law of refraction, from the arc sine of the ratio of the refraction numbers of two optical media. For water/glass, water/quartz, or water/polycarbonate, TIRF angles of 61.7°, 64.7°, or 56.2° are obtained, in each instance. The angle of the beam guide is smaller than the TIRF angles, in other words 55° instead of 61.7° in the case of water/glass, for example. Preferably, the angle of the beam guide is at most smaller than 20% of the TIRF angle. As a result, the excitation light is not totally reflected on the underside of the measurement chambers, but rather part of the light penetrates the carrier and the measurement chambers directly, and another part additionally reflects at the gold layer, and once again penetrates through the measurement chamber. This results in a stronger excitation of the fluorescence dyes. Since the excitation light is coupled into the transparent carrier close to the TIRF angle, in other words at a slant, it enters into the openings of the gold layer, in the region of these openings, at an angle at which it cannot leave them again. This results in a more advantageous signal/noise ratio that the substance that lies on top is not irradiated with the excitation light.

The device has an incubation station for the biochips to be measured. In this way, biochips and proteo-liposomes are stored at a specific temperature for a period of time that can be set, so that a membrane that contains the transport system can form above the measurement chambers.

By means of the characteristics of the device as described, measurement cycles can be carried out with process control and in automated manner, whereby a measurement cycle, in each instance, essentially comprises prepping of the biochip for the measurement, subsequent optical measurement, and subsequent evaluation of the measurement data.

The sample manipulator consecutively performs the following steps in order to prepare for the measurement of the biochip: First, the biochip is equilibrated with a buffer solution. By means of the equilibration, the biochip is heated to a desired temperature, at which fluidity of the lipid membrane is assured. Only in the case of sufficient membrane fluidity are the lipids homogeneously distributed in the membrane. Afterwards, addition of proteo-liposomes takes place.

Excess lipids are removed by means of the subsequent washing with the buffer solution. In the case of biological membranes or cells, addition and incubation are sufficient, so that their membranes can close off the measurement chambers.

Subsequently, an active substance candidate is added. An active substance candidate is a substance, for example an organic molecule, that is assumed to have specific effects on the transport, in other words inhibits the transport, for example. Subsequently, the transport substrate, marked with a fluorescence dye or intrinsically fluorescent, is added, and passes through the membrane specifically by means of the transport system. Furthermore, a fluorescence-marked control substrate that can be spectrally separated is also added, and this cannot pass through the membrane or the transport system. Last, the biochip is introduced into the measurement region of the microscope.

After prepping of the biochip, a time-resolved fluorescence measurement of the substrate in the measurement chambers of the biochip is carried out, with process control, and the measurement data captured in this connection are processed. The measurement can also take place in multi-spectral manner, at different wavelengths.

After the fluorescence measurement, the time-resolved fluorescence intensity is determined by the data processing unit for the individual measurement chambers, by means of pattern recognition. A mathematical curve is fitted to the measurement data determined in this way, by means of a sub-program. The mathematical curve allows classification of the measurement chambers into three categories, specifically sealed measurement chambers with a fluorescence signal, sealed measurement chambers without a fluorescence signal, and open measurement chambers. The automatic differentiation is made using the parameters of the mathematical curve. Measurement data of sealed measurement chambers without a fluorescence signal and of open measurement chambers are rejected. For the measurement data that are not rejected, in other words for sealed measurement chambers with a fluorescence signal, the velocity constant for transport is calculated.

The data processing unit then preferably creates a histogram in which all the calculated velocity constants for transport are plotted against their frequency. From the histogram, a corresponding number of transport systems per measurement chamber is then assigned to the velocity constants for transport, in each instance. By means of the assignment, it is possible to standardize all the velocity constants for transport with one transport system per measurement chamber. The maximum of the histogram for a transporter is determined by means of a mathematical function, and reproduces the specific velocity for the transport system, at which the system transports the measured transport substrate by way of the membrane, with great precision. If the velocity constant for transport is lowered or raised in the presence of an active substance candidate, then the active substance candidate has inhibited or accelerated the transport system, in each instance, and can be considered as a potential medication, for example.

The invention will be described as an example, in a preferred embodiment, making reference to a drawing, whereby other advantageous details can be derived from the figures of the drawing.

In this connection, functionally similar parts are provided with the same reference symbols.

The figures of the drawing show, in detail:

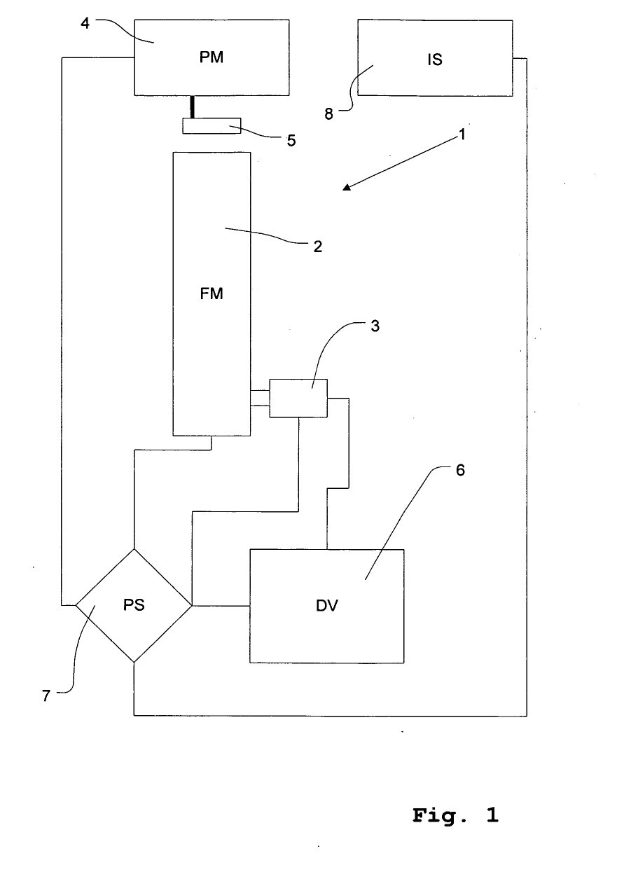

FIG. 1 a schematic representation of the measurement device 1;

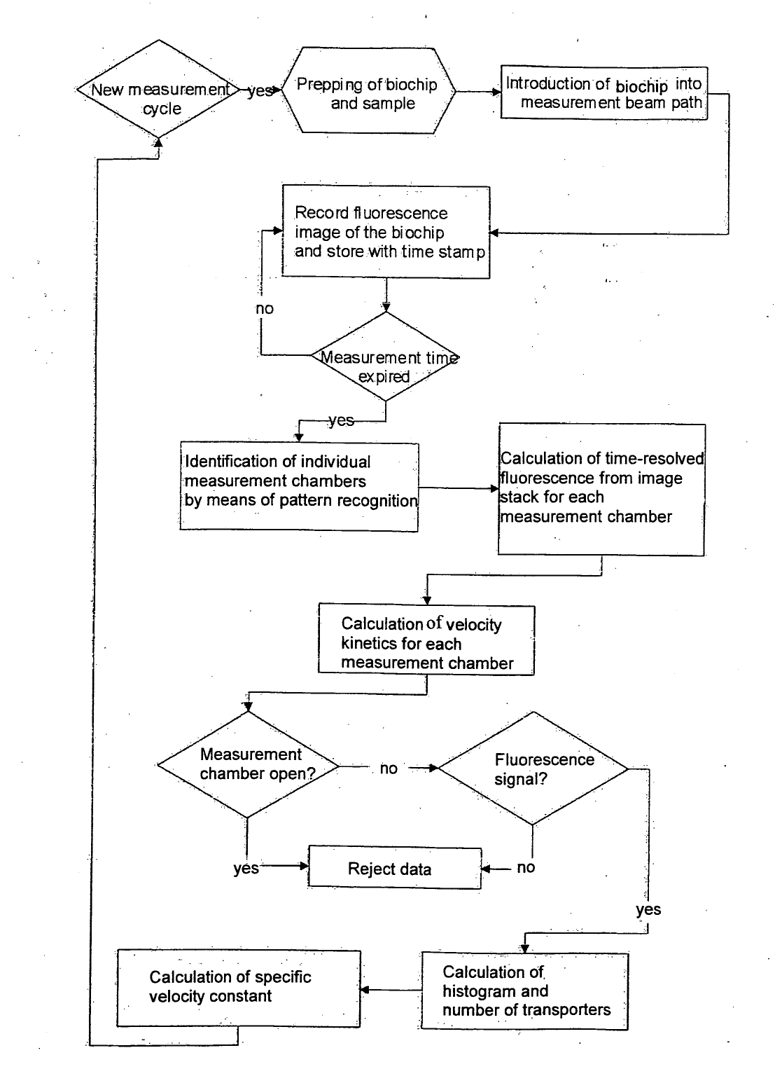

FIG. 2 a flow chart of the major steps of a measurement;

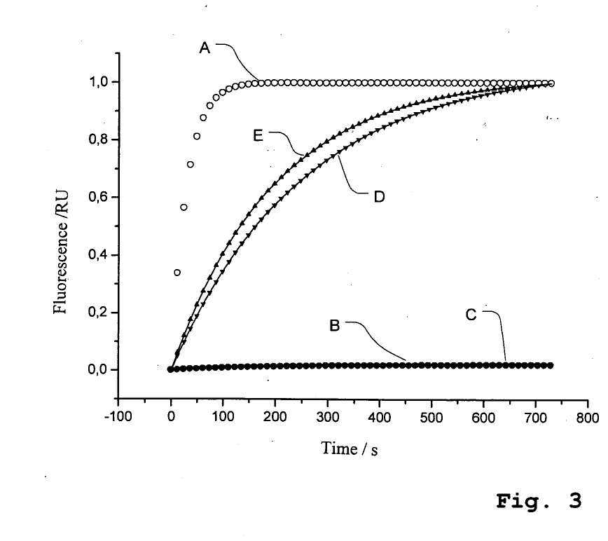

FIG. 3 measurement curves of the time-dependent fluorescence;

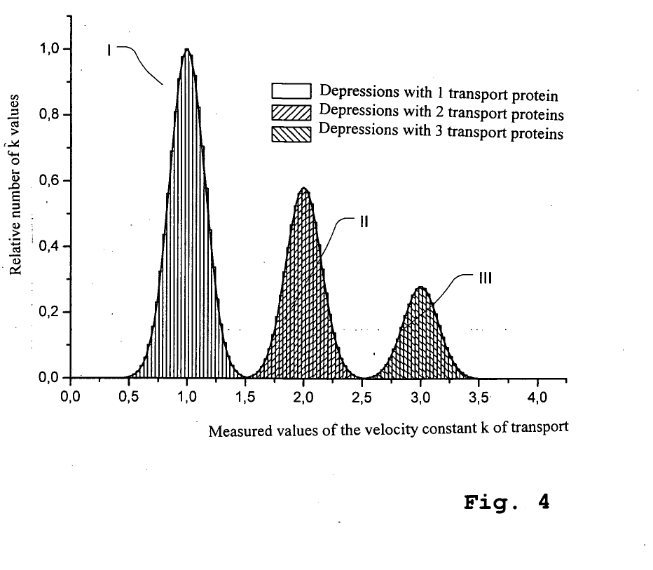

FIG. 4 a histogram with different velocity constants for transport; and

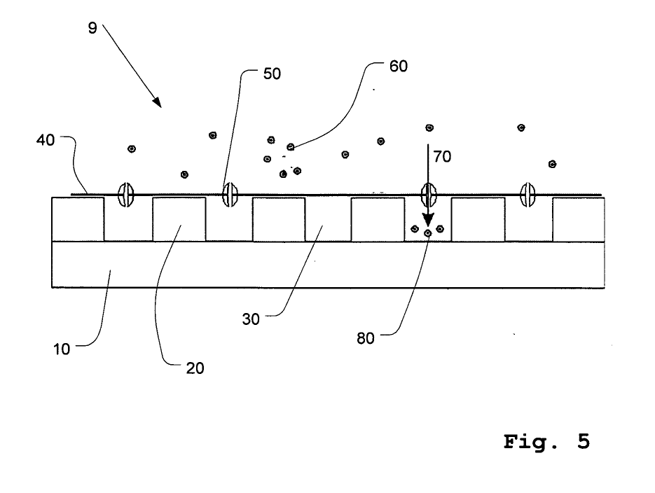

FIG. 5 a detail view of a biochip 9 in vertical section.

FIG. 1 shows a schematic representation of the measurement device 1. A TIRF microscope 2 (Total Internal Reflection Fluorescence), also referred to as FM in the figure, serves as the optical measurement device. However, a conventional fluorescence microscope can also be used. The functions of the TIRF microscope 2 are controlled in automated manner by a process controller 7 (PS). The microscope 2 is set up for multi-spectral measurements. In this way, it is possible to simultaneously measure a transport substrate 60 (see FIG. 5) and a control substrate (not shown), in parallel. By means of measuring the control substrate, it is determined whether the measurement chambers 30 (see FIG. 5) with the membrane 40 stretched over them (see FIG. 5) are sealed.

The prepping, preparation, and placement of a sample 40, 50, 60 (see FIG. 5) and of a biochip 9 (see FIG. 5) also take place in automated manner. For this purpose, a mechanical sample manipulator 4 (PM) is provided, which is also controlled by the process controller 7. The sample manipulator 4 has an accommodation device 5 for the biochip 9 (see FIG. 5). After preparation and prepping of the sample 40, 50 (see FIG. 5), the biochip 9 (see FIG. 5) is incubated in an incubation station 8, which is also controlled by the process controller 7. After an adjustable period of time, the sample manipulator 4 moves the accommodation device 5 with the biochip 9 (see FIG. 5) into the measurement beam path of the TIRF microscope 2, and the measurement is started. The fluorescence images are taken by a CCD camera 3, stored in the data processing unit 6 (DV), and automatically evaluated.

FIG. 2 shows a flow chart of the major steps of a measurement. The entire measurement process takes place automatically and is controlled by a process controller 7 (see FIG. 1). The process controller 7 first queries a variable as to whether a new measurement cycle is supposed to be started. If this is the case, a biochip 9 (see FIG. 5) is prepared for the measurement. First, the biochip 9 (see FIG. 5) is guided into the accommodation device provided for this purpose, by the sample manipulator 4, from a storage container (not shown), and this device is then brought into a preparation region of the device 1. A suitable biochip (see FIG. 5) consists of at least one layer 20 (see FIG. 5) that is transparent for the excitation light or the fluorescence light, respectively. It has measurement chambers 30 that are open at the top (see FIG. 5).

The biochip 9 (see FIG. 5) is then equilibrated with a buffer solution having a pH value set in fixed manner, using the sample manipulator 4. Furthermore, the sample manipulator 4 pipettes previously prepared proteo-liposomes onto the biochip 9 (see FIG. 5). The artificial proteo-liposomes contain carrier proteins or pore-forming channel proteins as a transport system. Afterwards, the biochip 9 (see FIG. 5) is stored in the incubation station 8 for an adjustable period of time. By means of incubation at a specific temperature, the lipids in the proteo-liposomes become fluid and form membrane layers 40 (see FIG. 5), which close and seal the individual measurement chambers 30 (see FIG. 5) of the biochip 9 (see FIG. 5). During subsequent washing with buffer solution, excess lipid vesicles and transport systems are removed.

However, native biomembranes or cells can also be used, thereby making it possible to not only determine transport velocities, but also to measure secretion rates from cells. For biological membranes or cells, the steps are reduced to an addition and subsequent incubation, in order to seal off the individual measurement chambers 30 (see FIG. 5) by means of the biological membranes, and a washing step.

Subsequently, the sample manipulator 4 pipettes the transport substrate 60 (see FIG. 5), which has been marked with a fluorescence dye, and the control substrate onto the biochip 9 (see FIG. 5). So that the two substrates can be measured in parallel in different wavelength ranges, they are marked with different fluorescence dyes that can be spectrally separated. In general, an active substance candidate is also added. This can be an inhibitor, for example, which bonds to the transport system 50 (see FIG. 5).

After the prepping phase, the sample manipulator 4 guides the biochip 9 (see FIG. 5) into the measurement region of the fluorescence microscope 2. In the measurement region, the substrate dyes are excited with a laser at a point of the biochip 9 (see FIG. 5), and the fluorescence emission is measured with a CCD camera 3. The recorded fluorescence images are provided with a time stamp and stored in the data processing unit 6. In this manner, a stack of images is produced, which contains information about the change in fluorescence over time.

Since the change in fluorescence was measured during a defined period of time, the images are evaluated by means of a pattern recognition routine, and the fluorescence signals are assigned to individual measurement chambers 30 (see FIG. 5). The data processing unit 6 then calculates measurement data points that reproduce the fluorescence progression during the measurement time period, from the time stamp and the time-dependent fluorescence intensity of each measurement chamber 30 (see FIG. 5).

Afterwards, the data processing unit 6 fits a mathematical curve to the measurement data points for each measurement chamber (see FIG. 3).

In an ideal case, an individual measurement chamber 30 (see FIG. 5) is tightly sealed by a membrane 40 (see FIG. 5), in which there is just one transport system 50 (see FIG. 5). However, there is also the possibility that a measurement chamber (see FIG. 5) is not sealed but rather open, and thus both the substrate 60 (see FIG. 5) and control substrate can penetrate into the measurement chamber 30 (see FIG. 5). Furthermore, there is the possibility that a measurement chamber 30 (see FIG. 5) is sealed, but does not contain any transport system 50 (see

FIG. 5), and thus neither substrate 60 nor control substrate penetrate into the measurement chamber 30. Classification of the measurement chambers 30 into the three aforementioned categories then takes place using the curve progression, by means of a sub-program. The measurement data of open measurement chambers or of measurement chambers without fluorescence signal are rejected (the progression of atypical measurement curves is shown in FIG. 3).

The remaining measurement curves are evaluated further by the data processing unit 6, to determine the specific velocity constant. In this connection, a histogram in which all the calculated velocity constants for transport are plotted against their frequency is preferably produced by means of a sub-program (see FIG. 4). From the histogram, a specific number of transport systems per measurement chamber is assigned to each velocity constant for transport, and standardized with one transport system per measurement chamber. The specific velocity constant for a transport system, for transport of the predetermined substrate, is determined from the maximum of the histogram for this transport system (see FIG. 4).

In this way, a complete measurement cycle has been concluded. The measured biochip is moved out of the measurement region of the fluorescence microscope 2 by the sample manipulator 4, and if applicable, another biochip is prepared for measurement.

The device described can typically be used for screening of potential active substances within the scope of drug development. If the velocity constant for transport is lower (higher) in the presence of an active substance candidate than without the active substance, then this indicates that the active substance candidate has inhibited (accelerated) the transport system, and might be used as a potential medication. In such cases, the device 1 can automatically measure the active substance at different concentrations, in multiple measurement cycles, in order to automatically determine the binding constant and other properties.

FIG. 3 shows typical examples of measurement curves of the time-dependent fluorescence, which were measured using the device. Five types of different fluorescence curves A, B, C, D, E are shown, which typically occur when measuring a biochip. Each measurement curve can be assigned to a specific measurement chamber on the carrier of the biochip, in each instance.

Curve A shows the time progression of the fluorescence in a measurement chamber 30 (see FIG. 5) that is not or not completely covered by a membrane 40 (see FIG. 5). The measurement chamber 30 is therefore not sealed, and both the substrate 60 (see FIG. 5) and the control substrate with the fluorescence dyes that can be spectrally separated can diffuse into the measurement chamber, unhindered, within a very short period of time. The fluorescence in the wavelength range of the control substrate has therefore reached its maximal intensity after only a very short time.

Curve B shows an exemplary time progression of the fluorescence in a measurement chamber 30 that does not contain a transport system or an active transport system. The measured fluorescence intensity of the marked substrate is very low, and shows only a slight change during the measurement period. Curves A and B contain no useful measurement data, and are therefore automatically rejected by the data processing unit 6.

Curve C is similar to Curve B, but is measured in the spectrally separate wavelength range of the marked control substrate. The fluorescence intensity of the marked control substrate is very slight, and shows only a slight change during the entire measurement period. The control substrate is therefore excluded from the measurement chambers, and thus these are sealed.

Curve D shows the time progression of the fluorescence of the substrate in a measurement chamber 30 that is sealed and furthermore contains an active transport system.

Curve E shows the time progression of the substrate in a sealed measurement chamber 30 as in Curve D. However, it can be seen that time-dependent fluorescence increases more rapidly than in Curve D. This is due to the fact that two or more transport systems 50 are present in the membrane section above this measurement chamber 30. In order to calculate the specific velocity constant for the transport 70, the number of transport systems 60 therefore has to be taken into consideration. FIG. 4 shows how this is done.

FIG. 4 shows a histogram with different velocity constants for transport. In this connection, all the measured values of the velocity constant for transport k are plotted on the abscissa. The relative number of all the measured velocity constants for transport k, in other words their frequency, is plotted on the ordinate. The first peak I reproduces all the velocity constants that were measured in measurement chambers with one transport system. The second peak II then reproduces all the velocity constants that were measured in measurement chambers with two transport systems, and the third peak III accordingly reproduces all the velocity constants that were measured in measurement chambers 30 (see FIG. 5) having three transport systems 50 (see FIG. 5). From the histogram, the number of transport systems 50 per measurement chamber 30 can therefore be assigned to every velocity constant for transport.

By means of the histogram, it is possible for the data processing unit 6 to determine the velocity constants that belong to the maxima of the peaks, using a mathematical function, and to standardize them, and thus all the measured velocity constants, with one transport system per measurement chamber. The velocity constant for transport for a transport system 50 determined in this manner corresponds, with great accuracy, to the specific velocity constant of this transport system 50 for the transport substrate 60, under the selected experimental conditions.

FIG. 5 shows a detail view of a biochip. 9, as it can be used for the measurement device 1, in vertical section. The biochip 9 has a carrier 10 that consists of a layer of glass that is transparent for exciting fluorescence light. Another layer 20 of silicon dioxide is disposed on the carrier 10. This layer has depressions that are configured as measurement chambers 30 that are open to the top. The measurement chambers 30 have an inside diameter of about 200 nm; the depth is about 500 nm.

For a measurement, a lipid membrane 40 is applied to the surface of the biochip 9, so that the measurement chambers 30 are sealed off. The lipid membrane 40 is a lipid layer that contains transport proteins 50. One or more substrate molecules 60 that can be detected with fluorescence methods, which is marked with a fluorescence dye, are applied to the lipid membrane 40. The substrate molecules 60 are then transported into the measurement chamber 30 by the transport proteins 50, by way of the membrane 40. In a measurement, excitation light (not shown) is radiated in at a slant from below, at a TIRF angle. At the transition from the carrier 10 to the measurement solution (not shown) in the measurement chamber 30, an evanescent field is generated in the case of total reflection of the light, which field excites the substrate molecules 80 in the measurement chamber 30, but not the substrate molecules 60 above the lipid membrane 40. In the case of biochips having a reflective top (not shown), the angle of the beam guide of the measurement device 1 is smaller than the TIRF angle.

The time-dependent transport 70 of the substrate molecules 80 by means of the transport proteins 50 contained in the membrane 40, into the measurement chambers 30, is specific to the transport system 50 contained, and can be determined by means of time-resolved fluorescence measurements, as was described above. The specific velocity constant of a transport system 50 for the transport substrate 80 is measured by means of the measurement device 1. For development of new medications, active substance candidates (not shown) are added. These bind, for example, to the transport protein 50, thereby changing the velocity constant of the transport 70 by way of the membrane 40. An effect of the active substance candidate is documented by means of the measured change in the velocity constant, and this can be therapeutically significant. Thus, the development of new medications can be significantly improved, both quantitatively and qualitatively, by means of the measurement device 1 and the measurement method described.

### REFERENCE SYMBOL LIST

1. measurement device
2. fluorescence microscope
3. CCD camera
4. sample manipulator
5. accommodation device for biochip
6. data processing unit
7. process controller
8. incubation station
9. biochip
10. carrier layer
20. layer
30. measurement chamber
40. lipid layer
50. transport protein
60. substrate molecule
70. transport
80. transported substrate molecule

1. Device (1) for optical measurement of properties of transport systems in membranes, particularly of carrier proteins or channel proteins, as well as secretion mechanisms, wherein it has an optical measurement device (2), a data processing unit (6) for capture and evaluation of measurement data, and a process controller (7).

2. Device (1) according to claim 1, wherein the optical measurement device (2) is a TIRF microscope.

3. Device (1) according to claim 1, wherein a sample manipulator (4) that can be controlled by the process controller (7) is provided for the device (1).

4. Device (1) according to claim 1, wherein the device (1) is set up for measuring biochips (9) that have a transparent layer (20) having multiple measurement chambers (30).

5. Device (1) according to claim 1, wherein the optical measurement device (2) has a beam guide whose angle is smaller than a TIRF angle, preferably at most smaller than 20% of the TIRF angle.

6. Device (1) according to claim 1, wherein the device (1) has an incubation station (8) for the biochips (9) to be measured, which can be controlled by the processor controller (7).

7. Device (1) according to claim 1, wherein the device (1) is configured to carry out measurement cycles with process control and in automated manner, whereby a measurement cycle, in each instance, essentially comprises prepping of the biochip (9) for the measurement, a subsequent optical measurement, and a subsequent evaluation of the measurement data.

8. Device (1) according to claim 1, wherein the sample manipulator (4) is configured for carrying out the following steps on the biochip (9):
a) equilibration with a buffer solution,
b) addition of proteo-liposomes, biological membranes, or cells,
c) washing with buffer solution,
d) addition of substrates and/or active substance candidates,
e) placement in the measurement region.

9. Device (1) according to claim 1, wherein the device (1) is configured for carrying out a time-resolved fluorescence measurement of the measurement chambers (30) of the biochip (9) after prepping of the biochip (9), and for capturing and processing the measurement data.

10. Device (1) according to claim 1, wherein the data processing unit (6) is set up for carrying out the following steps after the fluorescence measurement:
a) determination of the time-resolved fluorescence intensity for the individual measurement chambers (30), in each instance, by means of pattern recognition,
b) fitting of a mathematical curve to the time-resolved fluorescence intensity,
c) classification of the measurements chambers (30), on the basis of the mathematical curve, in one of the three following categories: i) sealed measurement chambers with a fluorescence signal, ii) sealed measurement chambers without a fluorescence signal, iii) open measurement chambers, and
d) rejection of the measurement data of sealed measurement chambers without a fluorescence signal and of open measurement chambers, and
e) calculation of a parameter for the velocity of transport, preferably of the velocity constant for transport, for each sealed measurement chamber with a fluorescence signal.

11. Device (1) according to claim 1, wherein the data processing unit (6) is set up for performing the following steps:
a) plotting of all calculated velocity constants for transport against their frequency in a histogram,
b) assignment of a corresponding number of transport systems per measurement chamber (30) to the velocity constants, in each instance,
c) determination of a specific velocity constant of a transport substrate (60) used for a transport system (50) per measurement chamber (30).

12. Method for optical measurement of properties of transport systems (50) in membranes (40), particularly of carrier proteins or channel proteins, as well as secretion mechanisms, which comprises the following steps:
a) determination of the time-resolved fluorescence intensity for individual measurement chambers of a biochip (9), in each instance, by means of pattern recognition,
b) fitting of a mathematical curve to the time-resolved fluorescence intensity,
c) classification of the measurement chambers (30), on the basis of the mathematical curve, in one of the three following categories: i) sealed measurement chambers with a fluorescence signal, ii) sealed measurement chambers without a fluorescence signal, iii) open measurement chambers.

13. Method according to claim 12, wherein it comprises the following steps:
d) rejection of the measurement data of sealed measurement chambers without a fluorescence signal and of open measurement chambers, and
e) calculation of a parameter for the velocity of transport, preferably of the velocity constant for transport, for each sealed measurement chamber with a fluorescence signal.

14. Method according to claim 12 wherein it comprises the following steps:
f) plotting of all calculated velocity constants for transport against their frequency in a histogram,
g) assignment of a corresponding number of transport systems (50) per measurement chamber (30) to the velocity constants, in each instance,
h) determination of a specific velocity constant of a transport substrate used for a transport system (50) per measurement chamber (30).
